(19) United States
(12) Patent Application Publication
(10) Pub. No.: US 2005/0060924 A1
(43) Pub. Date: Mar. 24, 2005

(54) Device for attaching an advertising display to a hose

(76) Inventors: Paul Feucht, Houston, TX (US); Rich Rosenhagen, Houston, TX (US)

Correspondence Address: G. Alan Witte;Law Offices of G. Alan Witte, Suite 920, 6750 West Loop South, Bellaire, TX, 77401, US

(21) Appl. No.: 10/665,251

(22) Filed: Sep. 19, 2003

(51) Int. Cl. G09F 3/18

(52) U.S. Cl. 40/660

(57) ABSTRACT

A device for attaching an advertising display to a hose, comprising a cylindrically shaped foam insert designed for placing on the hose and a covering adapted to at least substantially cover the foam insert, wherein the covering includes an advertising display.

### BACKGROUND OF THE INVENTION

1. Field of the Invention

The present invention relates to a device and method for attaching an advertising display to a hose. More particularly, the invention provides a cylindrically shaped foam insert and a covering having an advertising message printed thereon which covers the foam insert and is secured to the hose.

2. Description of the Related Art

The use of advertising at gasoline service stations is well-known in the art. Most service stations have stand-alone signs or advertising that appears on the face of the gasoline pump. A problem with these types of advertisements is that they do not take advantage of the time in which a customer pumps gasoline into a vehicle. An additional problem with these types of advertisements is that they cannot be easily and inexpensively interchanged with other advertising messages.

U.S. Pat. No. 5,058,637 relates to a message display boot for a fuel dispensing nozzle. A flexible plastic boot is provided which fits over a portion of the nozzle. At the top of the boot is a message platform which may be used for advertising. The display boot permits the advertising message to be periodically changed. This boot performs no function other than advertising. The boot provides a small surface area on which advertising can be placed and the advertising is often soiled when gasoline splashes out of the tank. Additionally, the boot may not fit a selected gasoline nozzle and the boot is not designed for placement anywhere other than gasoline nozzles. A number of patent assigned to Alvem ASA, Oslo (NO), including U.S. Pat. Nos. 6,289,616, 6,237,262 and 6,233,855, relate to similar message displays for fuel dispensing nozzles.

U.S. Pat. No. 6,233,858 relates to an apparatus for providing advertisement on a gasoline pump hose. The apparatus includes a frame with a slide located on one edge that can be slid into a slide housing located on a hose connector collar. The hose connector collar is connected to the gas pump hose by a clamp located at opposite ends of the hose connector collar. The advertising message is placed within the frame at the eye level of a customer of the service station. This apparatus performs no function other than advertising. This apparatus has not seen wide scale use due in part to the high cost of the apparatus. (The high cost of this apparatus is due to its complexity.)

There are a number of shortcomings with prior art devices for advertising at the self-service pumps at service stations. First, customers become irritated or annoyed when advertising enters more and more aspects of their lives, particularly when the method or device of advertising provides no function other than advertising. If the method or device of advertising provides a useful function for the customer at a self-service gas station, the customer is much more likely to accept and act on the advertising message. Also, it is a shortcoming if the device is complicated or difficulty to use. Further, a significant shortcoming of some prior art devices is their high cost. An additional shortcoming of some prior art devices is that the advertising message cannot be easily and inexpensively interchanged with a new advertising message.

### SUMMARY OF THE INVENTION

Accordingly, a need has arisen for a device for attaching an advertising display to a hose which also provides useful functions in addition to advertising.

In accordance with the present invention, a device and method is described for attaching an advertising display to a hose comprising a cylindrically shaped foam insert designed for placement on the hose and a covering adapted to at lease substantially cover the foam insert, wherein the covering includes an advertising display.

Accordingly, an object of the present invention is to provide an inexpensive method of attaching an advertising display to a hose. A further object of the present invention is to provide a device which also provides useful functions in addition to advertising. A still further object of the present invention is to provide a device which allows the advertising message to be easily and inexpensively interchanged with a new advertising message.

### BRIEF DEDSCRIPTION OF THE DRAWINGS

A better understanding of the invention can be obtained when the detailed description of exemplary embodiments set forth below is considered in conjunction with the attached drawings in which:

FIG. 1 is a prospective view of the device of the present invention for attaching an advertising display to a hose.

FIG. 2 shows a preferred embodiment of the individual pieces which make up the covering.

### DETAILED DECRIPTION OF THE EXEMPLARY EMBODIMENTS

The present invention relates to a device and method for placing advertising on a hose.

The present inventive product is advantageous over known devices and methods for advertising on self-service gasoline pump hoses and on other hoses. The present invention provides an inexpensive method of attaching an advertising display to a hose. Also, as discussed below, the device performs functions in addition to advertising and the advertising message can be easily and inexpensively interchanged with a new advertising message.

The device and method of advertising according to the present invention is useful at a number of locations. A preferred use of the device of the present invention is at gasoline service stations, and particularly on the self-service gasoline pump hoses. Here, as discussed below, the device performs several functions other than advertising. The device of the present invention may also be used on the air and water lines at a gasoline service station. Further, the device and method of the present invention may be used at garages or other businesses which change a customer's oil, and particularly on the oil hoses that the mechanics use to put oil in the vehicle. Still further, the device may be placed on hoses at vehicle inspection stations.

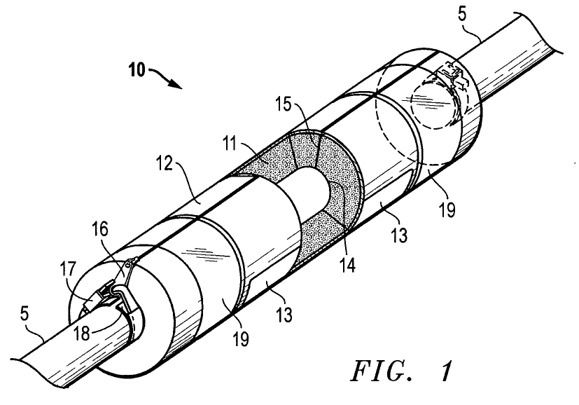

FIG. 1 shows the device 10 of the present invention attached to a hose 5. The device 10 comprises a foam insert 11 and a covering 12. The covering 12 includes an area 13 for an advertising display (not shown). The foam insert 11 preferably has a hollow core 14. The foam insert 11 includes a slit 15 designed for placing the foam insert 11 over the pipe 5. The hollow core 14 is preferably sized to fit various hose 5 sizes. Most preferably, the hollow core 14 has a diameter of about 1.5 inches.

The foam insert 11 may be made from any suitable, flexible foam. Preferably, the foam insert 11 is resistant to harsh fuels and other chemical additives. Preferably, the foam insert 11 is flexible enough to bend when the hose 5 bends. Also, preferably, the foam insert 11 is flexible enough to fit various size hoses 5.

The covering 12 may be made from any suitable substance including plastic, fabric, etc. Preferably, the covering 12 is resistant to harsh fuels and other chemical additives. The advertising may be placed on the covering 12 in the area 13 via any suitable means including, screen printing, pad printing, dye sublimation, etc. Preferably the printing is resistant to harsh fuels and other chemical additives. The printing may be done with fluorescent ink. The advertising message can be easily and inexpensively interchanged with a new advertising message by removing covering 12 and replacing it with a new covering 12 having a new advertising message. The advertising area 13 may be covered by a clear vinyl window or other glossy covering (not shown) to protect the advertising display or to further enhance the advertising display.

The covering 12 comprises a zipper 16 or other means to secure the covering 12 around the foam insert 11. Other suitable means of securing the covering 12 to the foam insert 11 include VELCRO, snaps, clips, etc.

The device 10 is preferably secured to the hose 5 by use of cable ties 17. The covering 12 preferably includes cable tie pockets 18. In use, once the foam insert 11 is in place around the pipe 5, one covers the foam insert 11 with the covering 12 and secures the covering 12 to the foam insert with the zipper 16 or other suitable means of securing the covering 12 to the foam insert 11. Then, one places the cable ties 17 in the cable tie pockets 18 and tightens the cable ties 17 to secure the device 10 to the hose 5.

Preferably the zipper 16 handle has a hole and the female end of the cable tie 17 is placed through this hole prior to fastening and securing the cable tie 17. This serves to prevent the opening of the zipper 16 after installation of the device 10.

Device 10 may include one or more reflective strips 19. The reflective strips 19 serve several functions. The reflective strips 19 serve to catch the customer's eye, particularly at night, when the customer pulls up to the gas station. Catching the customer's eye is important for several reasons. First, it improves the visibility of the gasoline pumps and helps to prevent the situation were a driver hits the pumps. Also, catching the customer's eye is important in directing the customer to the advertisement on the device 10. Reflective strips 19 also serve to aid the customer at a gas station in determining whether or not the hose nozzle remains in the gas tank opening, and helps to avoid the situation where a customer drives away with the gas hose nozzle still in the gas tank opening.

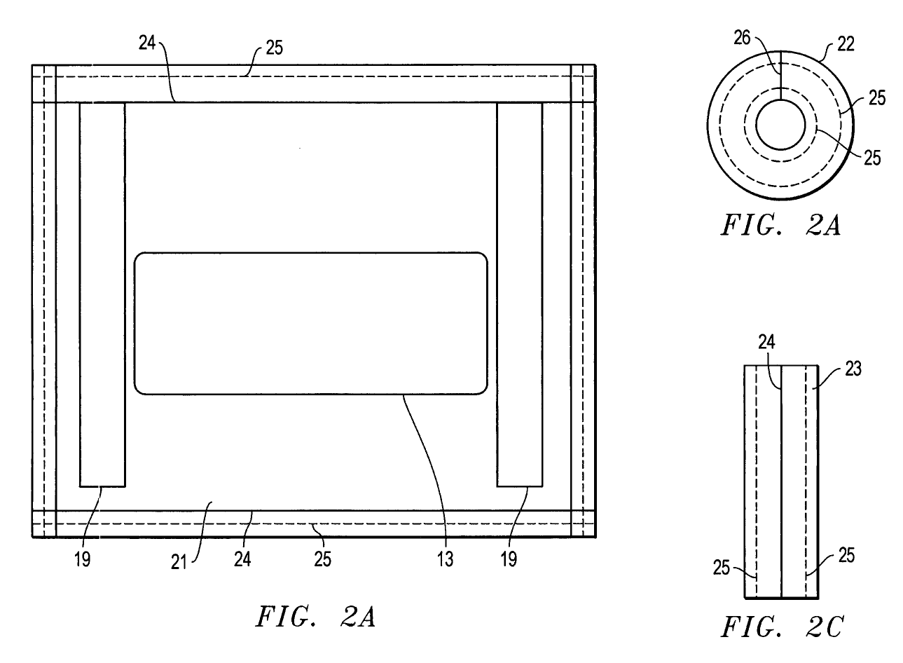

FIG. 2 shows the individual pieces which make up the covering 12. A large rectangular piece 21 is designed and cut to cover the foam insert 11. Two small rectangular pieces 23 are used to form the cable tie pockets 18. Two small circular pieces 22 are designed and cut to cover the sides of the foam insert 11 and connect the large rectangular piece 21 with the cable tie pockets 18. The small circular pieces 22 include a slit 26 designed for placing the covering 12 on the hose 5. In this drawing, interior solid lines 24 represents fold lines, while interior dashed lines 25 represent sew lines for attaching a selected piece to another piece. FIG. 2 also shows the area for advertising display 13 and the reflective strips 19.

An important feature of the device 10 and method of the present invention for attaching an advertising display to a hose is that the present invention provides several functions in addition to advertising. When attached to a self-service gasoline hose, the device 10 of the present invention improves the visibility of the hose while inserted in the gas tank opening to help prevent drive off accidents. Additionally, the device 10 of the present invention can help protect the finish of automobiles when hoses are dragged along or across the vehicle, i.e., the device 10 can help prevent a hose from marring the vehicle or can help prevent the gas tank nozzle or other nozzle from scratching the vehicle. Further, the device 10 of the present invention can be used to handle hoses without the user getting his hands dirty.

The advertising shown on the device 10 may be any advertising suitable for the device 10 located on a hose 5. At a gas station, the advertising may be directed to encourage the customer to enter the service station building and purchase items, for example, lottery tickets, drinks or food sold there, or oil or other automotive products sold there. At a garage or service station which changes oil, the advertising may relate to the brands of oil sold or may be designed to encourage the customer to purchase a premium grade of oil over a standard grade of oil.

All patents referred to herein are hereby incorporated by reference in their entireties.

Having described the invention above, various modifications of the techniques, procedures, materials, and equipment will be apparent to those skilled in the art. It is intended that all such variations within the scope and spirit of the invention be included within the scope of the appended claims.

1. A device for attaching an advertising display to a hose, comprising:
a cylindrically shaped foam insert designed for placement on the hose, and
a covering adapted to at least substantially cover the foam insert,
wherein the covering includes an advertising display.

2. The device of claim 1, wherein the covering is attached to the foam insert.

3. The device of claim 2, wherein the covering is attached to the foam insert with a zipper.

4. The device of claim 2, wherein the covering is attached to the foam insert with VELCRO.

5. The device of claim 1, wherein the covering is secured to the hose.

6. The device of claim 5, wherein the covering is secured to the hose with at least one cable tie.

7. The device of claim 1, wherein the foam insert has a hollow core.

8. The device of claim 1, wherein the foam insert has a slit designed for placing the foam insert on a hose.

9. The device of claim 1, wherein the covering includes formed pockets for cable ties.

10. The device of claim 1, further comprising at least one reflective strip attached on the covering.

11. The device of claim 1, further comprising a glossy covering secured to the covering and covering the advertising display.

12. A device for attaching an advertising display to a hose, comprising:
a cylindrically shaped foam insert designed for placement on the hose,
a covering adapted to at least substantially cover the foam insert, wherein the covering includes an advertising display,
a first securing means for securing the covering to the foam insert, and
a second securing means for securing the device to the hose.

13. The device of claim 12, wherein the foam insert has a hollow core.

14. The device of claim 12, wherein the foam insert has a slit designed for placing the foam insert on a hose.

15. The device of claim 12, wherein the first means for securing the covering to the foam insert comprises a zipper.

16. The device of claim 12, wherein the first means for securing the covering to the foam insert comprises VELCRO.

17. The device of claim 12, wherein the second means for securing the device to the hose comprises cable ties.

18. The device of claim 12, wherein the covering includes formed pockets for cable ties.

19. The device of claim 12, further comprising at least one reflective strip attached on the covering.

20. The device of claim 12, further comprising a glossy covering secured to the covering and covering the advertising display.

21. A method for placing advertising on a hose, comprising the steps of: obtaining a device, comprising:
a cylindrically shaped foam insert designed for placement on the hose,
a covering adapted to at least substantially cover the foam insert, wherein the covering includes an advertising display, and placing the device on the hose.

22. The method of claim 21, further comprising the step of securing the device to the hose.

23. The method of claim 22, wherein the securing step is accomplished using cable ties.

24. The method of claim 21, wherein the placing step comprises first placing the foam insert on the hose, then covering the foam insert with the covering.

25. The method of claim 21, further comprising the step of securing the covering to the foam insert.

26. The method of claim 25, wherein the securing step is accomplished using a zipper.

27. The method of claim 25, wherein the securing step is accomplished using VELCRO.
